(19) United States
(12) Patent Application Publication
(10) Pub. No.: US 2017/0142322 A1
(43) Pub. Date: May 18, 2017

(54) SYSTEMS AND METHODS FOR SELECTIVELY PROVIDING REMOTE ACCESS TO ONE OR MORE CAMERA SYSTEMS

(71) Applicant: Elwha LLC, Bellevue, WA (US)

(72) Inventors: William David Duncan, Sammamish, WA (US); Roderick A. Hyde, Redmond, WA (US); Muriel Y. Ishikawa, Livermore, CA (US); Jordin T. Kare, San Jose, CA (US); Thomas Allan Weaver, San Mateo, CA (US); Lowell L. Wood, JR., Bellevue, WA (US)

(21) Appl. No.: 15/359,329

(22) Filed: Nov. 22, 2016

Related U.S. Application Data
(63) Continuation-in-part of application No. 13/402,737, filed on Feb. 22, 2012, now abandoned.

(51) Int. Cl. H04N 5/232

(52) U.S. Cl. CPC H04N 5/23206; H04N 5/23296; H04N 5/23212

(57) ABSTRACT

System and methods for identifying one or more out-of-network camera systems of interest and for enabling dynamic providing remote access to the one or more out-of-network camera systems are disclosed. In certain embodiments, identifying one or more out-of-network camera systems may include receiving a search query from a user, comparing search parameters included in the search query with information stored in a database and, based on the comparison, identify one or more camera systems satisfying the search query. In embodiments enabling providing remote access to one or more out-of-network camera systems, a request management system may receive a plurality of requests for accessing one or more camera systems, determine at least one selected request and corresponding selected requester from the plurality of requests, and provide access to the one or more camera systems to the selected requester.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)).

### PRIORITY APPLICATIONS

This U.S. patent application is a Continuation-in-part of U.S. patent application Ser. No. 13/402,737, titled SYSTEMS AND METHODS FOR ACCESSING CAMERA SYSTEMS, filed on Feb. 22, 2012, which application is hereby incorporated by reference in its entirety.

### RELATED APPLICATIONS

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### TECHNICAL FIELD

This disclosure relates to camera systems. More specifically, this disclosure relates to systems and methods for selectively providing remote access to one or more camera systems.

### SUMMARY

A system according to one embodiment for providing remote access to one or more camera systems includes a processor, a computer-readable medium coupled to the processor, and a plurality of units. The units may include a communication unit configured to receive a plurality of requests for remotely accessing a camera system from a plurality of requesters, a request determination unit configured to determine at least one selected request and corresponding selected requester from the plurality of requests; and an access control unit configured to provide access to the camera system to each selected requester.

### BRIEF DESCRIPTION OF THE DRAWINGS

FIG. 1 illustrates an exemplary system for providing remote access to one or more camera systems consistent with embodiments disclosed herein.

FIG. 2 illustrates an exemplary computer system for implementing embodiments of the present disclosure.

FIG. 3 illustrates a flow chart of an exemplary method for managing a request for access to one or more camera systems consistent with embodiments disclosed herein.

FIG. 4 illustrates a flow chart of an exemplary method for providing remote access to one or more camera systems consistent with embodiments disclosed herein.

FIG. 5 illustrates exemplary remotely accessible camera resources consistent with embodiments disclosed herein.

FIG. 6 illustrates an exemplary camera access schedule consistent with embodiments disclosed herein.

FIG. 7 illustrates an exemplary system for providing remote access to one or more camera systems allowing resale rights consistent with embodiments disclosed herein.

FIG. 8 illustrates an exemplary system for identifying one or more camera systems of interest to a user consistent with embodiments disclosed herein.

FIG. 9 illustrates a flow chart of an exemplary method for managing a camera search query from a user consistent with embodiments disclosed herein.

FIG. 10 illustrates a flow chart of an exemplary method for searching for one or more cameras of interest consistent with embodiments disclosed herein.

FIG. 11 illustrates an exemplary system for identifying one or more camera systems of interest to a user utilizing a search query weighting process consistent with embodiments disclosed herein.

### DETAILED DESCRIPTION

A detailed description of systems and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

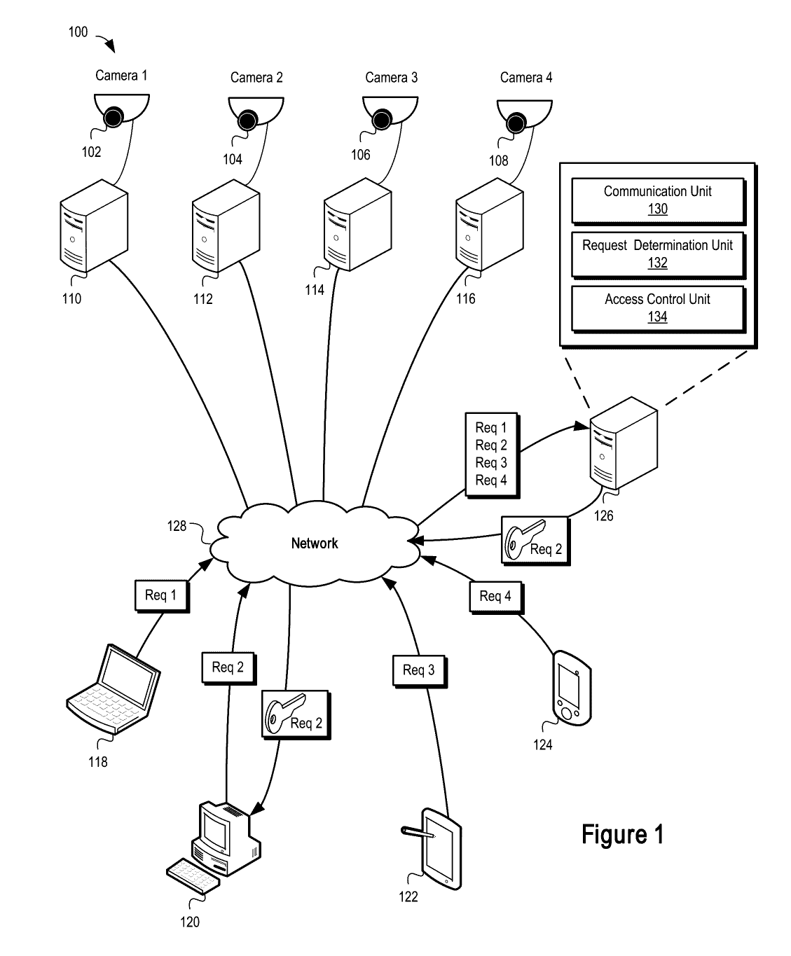

FIG. 1 illustrates an exemplary system 100 for providing remote access to one or more camera systems 102-108 consistent with embodiments disclosed herein. In certain embodiments, the one or more camera systems 102-108 may be communicatively coupled with one or more camera computer systems 110-116 configured to enable the one or more camera systems 102-108 to communicate with one or more devices and/or systems 118-126 communicatively coupled to a network 128. In further embodiments, the one or more camera systems 102-108 may include internal systems configured to allow the one or more camera systems 102-108 to directly interface with the network 128. The network 128 may comprise the Internet, a local area network, a virtual private network and/or any other communication network utilizing one or more electronic communication technologies and/or standards (e.g., cable, satellite, broadcast, cellular, wireless, Ethernet, infrared, Bluetooth™, etc).

The one or more camera systems 102-108 may comprise any remote camera system configured to capture images and store and/or transmit captured images electronically. For example, the one or more camera systems 102-108 may comprise webcams, unmanned camera systems, manned camera systems, still image camera systems, video camera systems, three-dimensional (3D) camera systems, wireless camera systems, and/or camera systems that include a plurality of discrete image capturing devices. In certain embodiments, the one or more camera systems 102-108 may include systems to capture and store and/or transmit audio (e.g., via a microphone or the like). The one or more camera systems 102-108 may further include one or more remotely accessible resources, discussed in more detail below.

One or more user devices 118-124 may be communicatively coupled to the network 128. Further, a request management system 126 may be communicatively coupled to the network 128. The one or more user devices 118-124, request management system 126, one or more camera computer systems 110-116, and/or one or more camera systems 102-108 may include software and/or hardware configured to enable electronic communication of information between the devices and/or systems 102-126 via the network 128 using any suitable communication technology and/or standard. For example, the one or more user devices 118 may be configured to access the one or more camera systems 102-108 and/or interface with the request management system 126 via the network 128. The devices and/or systems 102-126 may include computing devices that comprise at least one processor including, for example, a microprocessor, a microcontroller, logic circuitry, and/or the like. In some embodiments, the processor may include a special purpose processing device such as an ASIC, PAL, PLA, PLD, FPGA, or other customized or programmable device. The devices and/or systems 102-126 may further include a computer-readable storage device such as non-volatile memory, static RAM, dynamic RAM, ROM, CD-ROM, disk, tape, magnetic, optical, flash memory, or other computer-readable storage medium.

In certain embodiments, the one or more user devices 118-124 may comprise a laptop computer system, a desktop computer system, a smartphone (e.g., the Apple® iPhone™, the Motorola® Droid®, and the BlackBerry® Storm™), a tablet computer (e.g., the Apple® iPad™, the HP® Slate, and the Samsung® Galaxy™ Tablet), and/or any other device capable of communicatively interfacing with the one or more camera systems 102-108 and/or the request management system 126 via the network 128. The one or more user devices 118-124 may include software and/or hardware that may enable the one or more devices 118-124 to access the one or more camera systems 102-108; receive, render, and/or store content (e.g., images) received therefrom; and/or control certain accessible resources of the one or more camera systems 102-108.

Consistent with embodiments disclosed herein, the illustrated system 100 may enable users of the one or more user devices 118-124 to competitively request access to at least one remotely accessible resource of the one or more camera systems 102-108. Management of the process of selectively providing remote access may be facilitated by the request management system 126. As illustrated, the user devices 118-124 may transmit, via the network 128, requests for accessing at least one resource of at least one of the camera systems 102-108 to the request management system 126. For example, the users of the user devices 118-124 may wish to access a resource of “Camera 1” 102. Accordingly, as illustrated, user device 118 may generate and transmit a request access to “Camera 1” 102 (i.e., “Request 1”), user device 120 may generate and transmit a request access to “Camera 1” 102 (i.e., “Request 2”), user device 122 may generate and transmit a request access to “Camera 1” 102 (i.e., “Request 3”), and user device 124 may generate and transmit a request access to “Camera 1” 102 (i.e., “Request 4”). Requests may comprise a proposed exchange amount (monetary or non-monetary), an amount per image accessed, an amount for each instance of access to a resource of the camera system, an amount per period of access to a resource of the camera system, an request range, a request for access to a plurality of images captured by the camera system, a request for access for a particular amount of time, a request for access at a particular time, a request for access at a preferred time and/or time interval, and/or the like. In certain embodiments, the user devices 118-124 may access a preview use of the one or more camera systems 102-108 prior to generating and transmitting requests for use of a resource of the one or more camera systems 102-108.

The requests from the user devices 118-124 (i.e., “Request 1”, “Request 2”, “Request 3”, and “Request 4”) may be received by the request management system 126 via a communication unit 130 executing thereon configured to coordinate communication with other devices (e.g., user devices 118-124) communicatively coupled to request management system 126 via the network 128. Based on certain specified rules, a request determination unit 132 executing on the request management system 126 may determine at least one selected request and a corresponding selected requester (i.e., a corresponding user device 118-124) from the received requests (i.e., “Request 1”, “Request 2”, “Request 3”, and “Request 4”). For example, after receiving the requests from the user devices 118-124 for accessing a resource of “Camera 1” 102, the request determination unit 130 may determine that “Request 2” is a selected request. The request determination unit 130 may further determine that “Request 2” was received from user device 120.

After determining a selected request and a corresponding selected requester (i.e., a corresponding user device 118-124), the request determination unit 132 may communicate an indication of the selected user device 118-124 to an access control unit 134 executing on the request management system 126. The access control unit 134 may facilitate access by the selected user device 118-124 to the remotely accessible resource of the one or more camera systems 102-108. In certain embodiments, the access control unit 134 may facilitate access by the selected user device 118-124 to the remotely accessible resource by generating and transmitting via the network 128 a cryptographic access key, password, electronic license, access certificate, access cookie, and/or any other access/authentication credentials to the selected user device 118-124.

The cryptographic access key, password, electronic license, access certificate, access cookie, and/or any other access/authentication credentials or means of access authentication may be used by the selected user device 118-124 to access the remotely accessible resource of the one or more camera systems 102-108 in conjunction with access control methods executed by the one or more camera systems 102-108, camera system computers 110-116, request management system 126, and/or the user devices 118-124. For example, as illustrated, after determining that user device 120 transmitted a selected request (i.e., “Request 2”) for accessing a resource of “Camera 1” 102, the request determination unit 132 may communicate to the access control unit 134 an indication that user device 120 was associated with the selected request. The access control unit 134 may then generate and transmit to user device 120 an access key via the network 128 that may be utilized by the user device 120 to access the resource of “Camera 1” 102 in conjunction with access control methods executed by “Camera 1” 102, its associated camera computer system 110, the request management system 126, and/or the user device 120 itself.

The request determination unit 132 may determine a selected request based on a variety of factors. In certain embodiments, the selected request may be a highest request of the submitted requests. In some embodiments, a selected request may be based on the duration of requested access (e.g., longest or shortest). Selected requests may be further based on a variety of factors including, for example, viewing conditions of the one or more camera systems 102-108, weather conditions proximate to the one or more camera systems 102-108, viewing orientations of the one or more camera systems 102-108, the location of the one or more camera systems 102-108 relative to at least one particular person, the location of the one or more camera systems 102-108 relative to at least one particular location, the location of the one or more camera systems 102-108 relative to at least one particular object, the location of the one or more camera systems 102-108 relative to a particular number of persons, the availability of access to a plurality of discrete image capturing devices of the one or more camera systems 102-108, and/or the like. In certain embodiments, a request value may be determined by a function based on a variety of factors. In some embodiments, this function may be linear, non-linear, utilize numerical values, Boolean conditions, and/or algorithmic or program-based evaluation techniques.

Users of the one or more user devices 118-124 may competitively request on many types of access to the one or more camera systems 102-108. For example, users may request exclusive access to the one or more camera systems 102-108, non-exclusive access to the one or more camera systems 102-108, access to the one or more camera systems 102-108 for a particular or preferred interval of time, access to the one or more camera systems 102-108 at a particular or preferred point in time, and the like. In certain embodiments, the particular access interval or point in time may begin for a user device 118-124 after the request management system 126 determines the particular user device 118-124 that submitted the selected request and/or when the access control unit 134 transmits access/authentication credentials to the selected user device 118-124.

As discussed above, the one or more camera systems 102-108 may include one or more remotely accessible resources. In certain circumstances, users may request exclusive or non-exclusive access to at least one of the remotely accessible resources. In camera systems 102-108 that include a plurality of remotely accessible resources, different users may request exclusive or non-exclusive access to different resources of the plurality of resources. For example, a first user may request exclusive access to a first remotely accessible resource of a camera system, and a second user may request exclusive access to a second remotely accessible resource of the camera system. In this manner, multiple selected users may be provided simultaneous exclusive or non-exclusive access to different remotely accessible resources of the same camera system. Further, in circumstances where multiple users request non-exclusive access to the same remotely accessible resource of a camera system, multiple selected users may be provided simultaneous access to the same remotely accessible resource.

It will be appreciated that a number of variations can be made to the architecture and relationships presented in connection with FIG. 1 within the scope of the inventive body of work. For example, certain functionalities of the request management system 126 may be included in the one or more camera systems 102-108, one or more camera computer systems 110-116, and/or one or more user devices 118-124. In some embodiments, other above-described system functionalities may be similarly distributed between the illustrated systems and/or devices 102-126. Thus, it will be appreciated that the system 100 of FIG. 1 is provided for purposes of illustration and explanation, and not limitation.

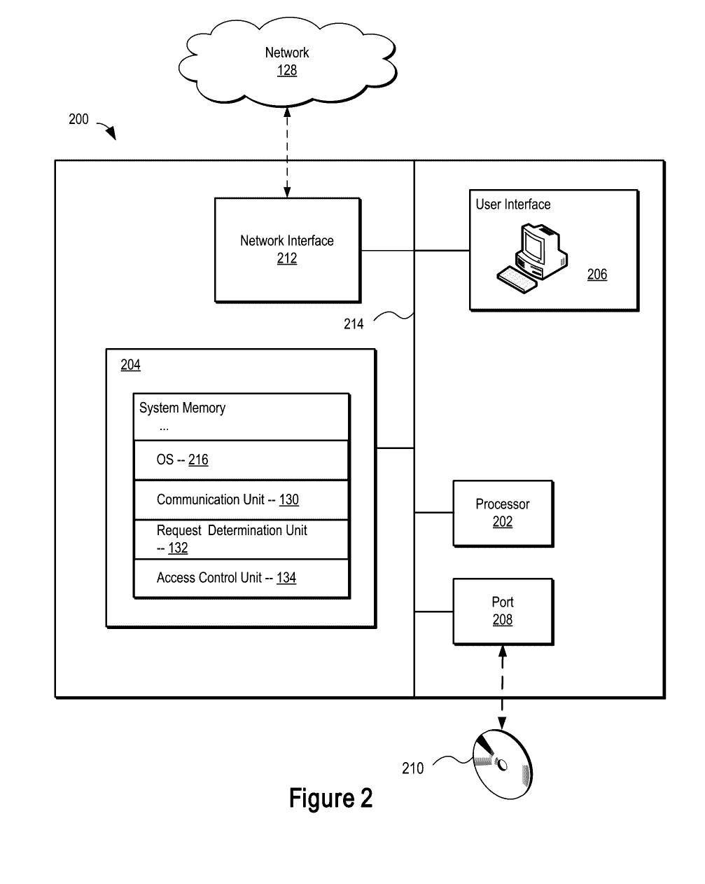

FIG. 2 illustrates an exemplary computer system 200 implementing embodiments of the present disclosure. For example, certain embodiments of the camera computer systems 110-116, the user devices 118-124, the request management system 126, and/or the search management system discussed in detail below may be implemented using certain elements of the exemplary computer system 200. In particular, the illustrated computer system 200 implements certain functionalities of the request management system 126. The exemplary system 200 may comprise a general-purpose computing device such as a personal computer or network server, or a specialized computing device such as a cellular telephone, PDA, portable audio or video player, electronic book reader, tablet, television set-top box, kiosk, gaming system, or the like. As illustrated in FIG. 2, the system 200 may include: a processor 202; system memory 204, which may include high speed random access memory (RAM), non-volatile memory (ROM), and/or one or more bulk non-volatile computer-readable storage mediums (e.g., a hard disk, flash memory, etc.) for storing programs, units, and other data for use and execution by the processor 202; a user interface 206 that may include a display and/or one or more input devices such as a touchscreen, a keyboard, a mouse, a track pad, and/or the like; a port 208 for interfacing with removable memory 210 that may include one more diskettes, optical storage mediums (e.g., flash memory, thumb drives, USB dongles, compact discs, DVDs, etc) and/or other computer-readable storage mediums; a network interface 212 for communicating with other systems via the network 128 using one or more communication technologies (e.g., wireless, Ethernet, infrared, Bluetooth, etc.), and one or more buses 214 for communicatively coupling the aforementioned elements.

The operation of system 200 may be generally controlled by the processor 202 by executing software instructions, programs, and/or units stored in the system memory 204. As shown in FIG. 2, the system memory 204 of the computing device 200 may include a variety of programs or units, which, when executed by the processor 202, can control the operation of system 200. For example, the system memory 204 may include an operating system (OS) 216 for managing and coordinating in part system hardware resources and providing for common services for execution of various applications. When implementing certain functionalities of the request management system 126 as illustrated, the system memory 204 may include the communication unit 130, the request determination unit 132, and/or the access control unit 134 that, when executed by the processor 202, cause the processor 202 to perform the methods and/or functionalities described above.

One of ordinary skill in the art will appreciate that the systems and methods described herein can be practiced with computing systems similar or identical to that illustrated in FIG. 2, or with virtually any other suitable computing systems, including computing systems that do not possess some of the components shown in FIG. 2 and/or computing systems that possess other components that are not shown. Thus it should be appreciated that FIG. 2, is provided for purposes of illustration and not limitation.

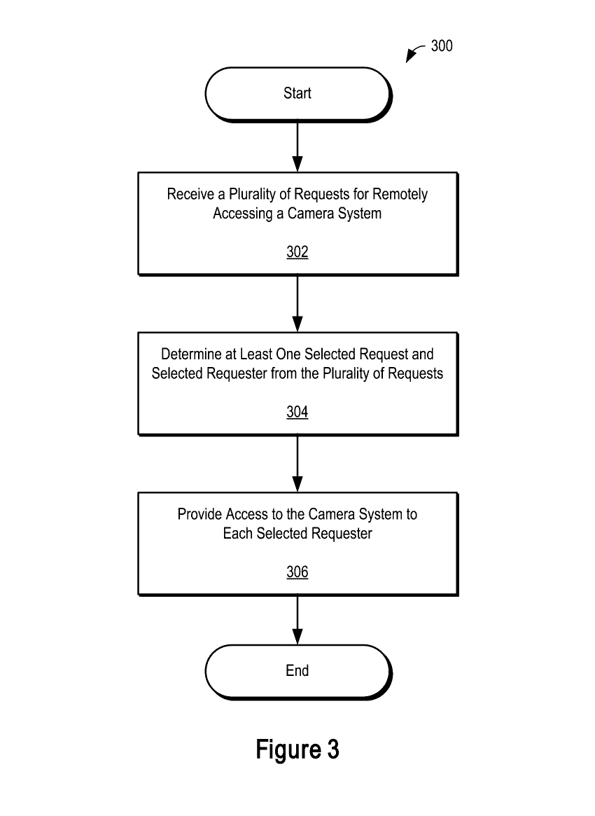

FIG. 3 illustrates a flow chart of an exemplary method 300 for managing a process of selectively providing remote access for access to one or more camera systems (e.g., camera systems 102-108) consistent with embodiments disclosed herein. At 302, a request management system (e.g., request management system 126) may receive a plurality of requests for accessing one or more camera systems from a plurality of requesters. In some embodiments, the received requests may be for accessing a remotely accessible resource of the one or more camera systems. The plurality of requests may be transmitted from one or more user devices (e.g., user devices 118-124) in communication with the request management system. Based on certain rules, at 304, the system may determine at least one selected request and a corresponding selected requester from the plurality of received requests. After determining a selected requester, at 304, the system may provide access to the one or more camera systems to the selected requester. In certain embodiments, providing access to the selected requester may be achieved by transmitting access/authentication credentials to a user device associated with the selected requester that may be utilized to access the one or more camera systems.

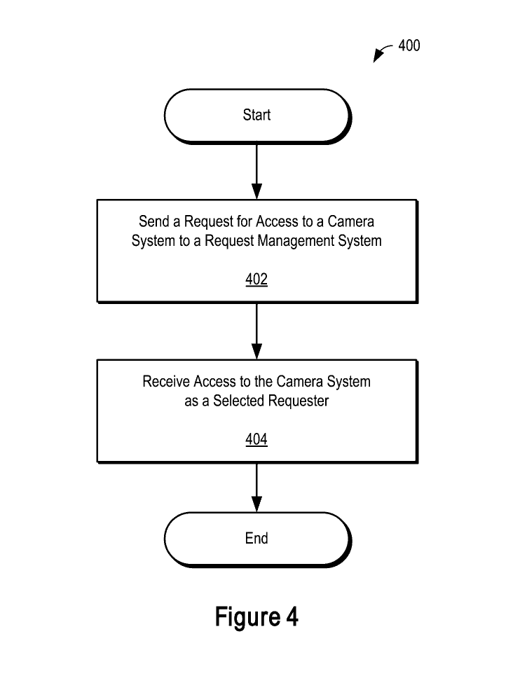

FIG. 4 illustrates a flow chart of an exemplary method 400 for providing remote access to one or more camera systems consistent with embodiments disclosed herein. At 402, a user may transmit via a user device (e.g., user devices 118-124) a request access to one or more camera systems (e.g., camera systems 102-108). In certain embodiments, the request may be a request access to a remotely accessible resource of the one or more camera systems. A remote request management system (e.g., request management system 126) may determine that the request submitted by the user is a selected request. If the request submitted by the user is a selected request, at 404, the user may receive access to the camera system. In certain embodiments, receiving access to the camera system may comprise receiving access/authentication credentials that may be utilized to access the one or more camera systems.

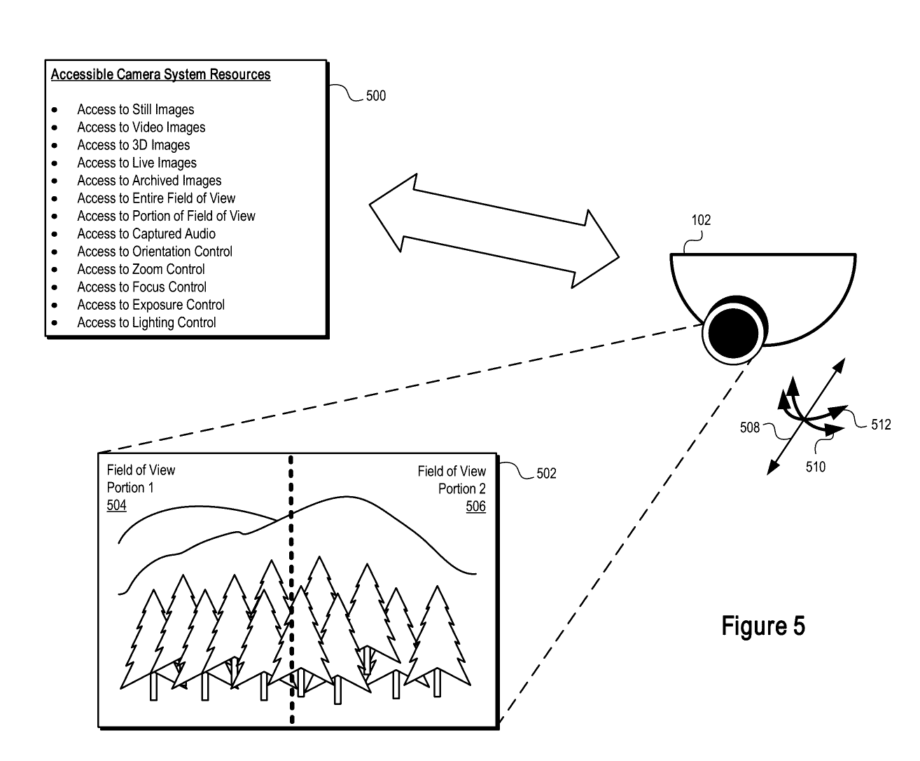

FIG. 5 illustrates exemplary remotely accessible camera resources 500 consistent with embodiments disclosed herein. As discussed above, certain embodiments may provide a system for users of one or more user devices (e.g., user devices 118-124) to competitively request access to at least one remotely accessible resource 500 of one or more camera systems (e.g., camera systems 102-108). In certain embodiments, the access may be to all remotely accessible resources 500 associated with a camera system. In further embodiments, the access may be to a subset of remotely accessible resources 500 associated with a camera system.

As illustrated, remotely accessible camera resources 500 may include access to still images captured by the camera system, access to video images captured by the camera system, access to 3D images captured by the camera system, access to live images captured by the camera system, access to archived (i.e., previously captured) images captured by the camera system, access to an entire field of view (e.g., field of view 502) of the camera system, access to a portion of a field of view of the camera system (e.g., “Field of View Portion 1” 504 or “Field of View Portion 2” 506), access to audio captured by an audio system included the camera system, access to orientation control of the camera system (e.g., tilt control 510 and pan control 512), access to zoom control 508 of the camera system, access to focus control of the camera system, and access to lighting control of the camera system. Remotely accessible camera resources 500 may include any other resources and/or functionalities of a camera system of interest to a requesting user. Moreover, certain camera systems may include one, a subset, or all the illustrated remotely accessible resources 500. Accordingly, the illustrated remotely accessible camera resources 500 are provided for purposes of illustration and explanation, and not limitation.

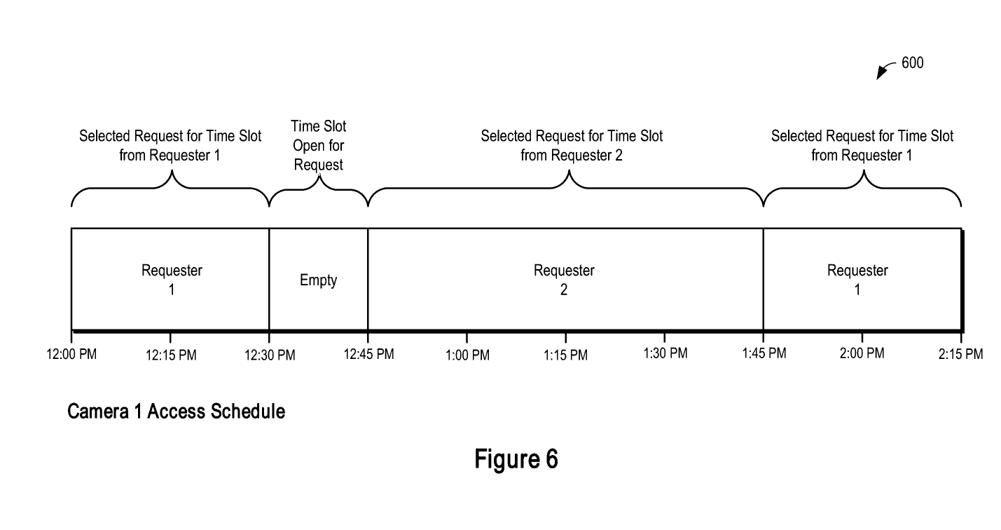

FIG. 6 illustrates an exemplary camera access schedule 600 consistent with embodiments disclosed herein. As discussed above, requests from users may comprise a request accessing the one or more camera systems 102-108 for a particular or preferred interval of time, a request accessing the one or more camera systems 102-108 at a particular or preferred point in time, and/or the like. In certain embodiments, the request management system 126 may generate a camera access schedule 600 for one or more of the remotely accessible resources 500 of the camera systems 102-108 based on selected requests.

The camera access schedule 600 may indicate which users (i.e., requesters) have placed selected requests for accessing a remotely accessible resource 500, what time slots (i.e., time intervals) each respective selected requester may have access to the remotely accessible resource 500, and/or any access time slots that have not been request and/or secured by a selected requester that may still be available for requesting. For example, as illustrated, “Requester 1” may place a selected request accessing the camera system 102-108 for a 30-minute time slot, preferably starting at 12:00 PM. The request management system 126 may then schedule “Requester 1” for access to the camera system 102-108 for a 30-minute time slot starting at 12:00 PM if the preferred time slot is available, or alternatively the first available 30-minute time slot if the 30-minute time slot following 12:00 PM is already reserved for another selected requester. “Requester 2” may place a selected request accessing the camera system 102-108 for a 60-minute time slot starting at 12:45 PM, and the request management system 126 may then schedule “Requester 2” for access to the camera system 102-108 for a 60-minute period starting at 12:45 PM. “Requester 3” may place a selected request during “Requester 2's” access time slot for accessing the camera system 102-108 at the next available 30-minute time slot. The request management system 126 may then schedule “Requester 3” for access to camera system 102-108 immediately following “Requester 2's” access time slot (e.g., from 1:45 PM to 2:15 PM). The unscheduled open time slot between “Requester 1's” access time slot and “Requester 2's” access time slot may remain available to be secured by a selected request from a user, and the request management system 126 may perform methods to solicit requests for this open time slot from users. By effectively scheduling and managing access to a remotely accessible resource 500 of the camera systems 102-108, the request management system 126 may increase the potential for user requesting, thereby increasing the potential revenue stream generated by the systems and methods disclosed herein.

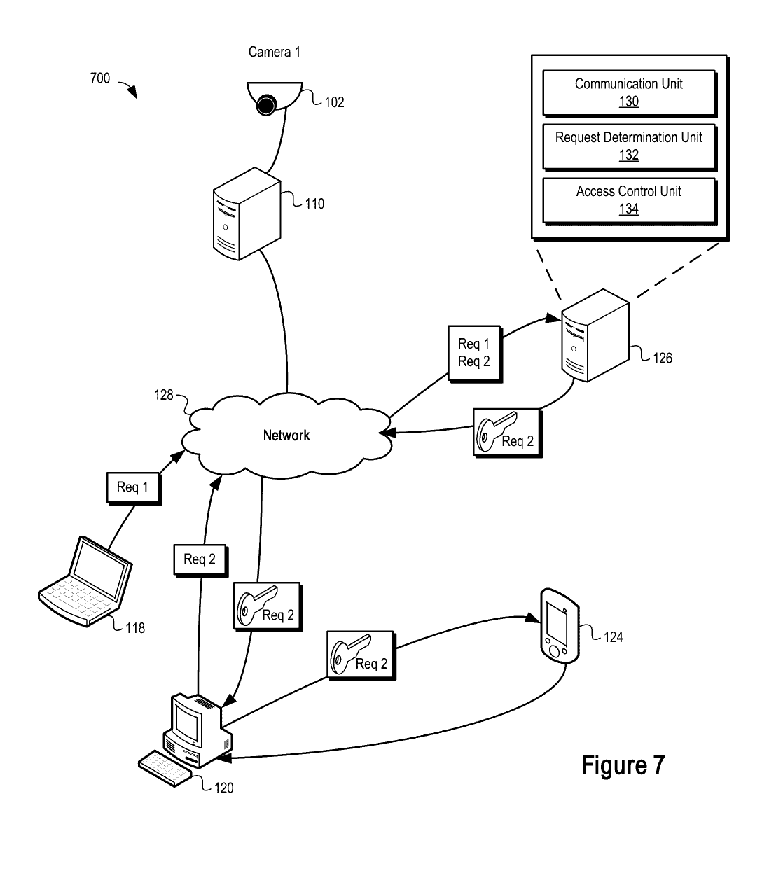

FIG. 7 illustrates an exemplary system 700 for providing remote access to one or more camera systems allowing the ability to provide secondary access to third parties consistent with embodiments disclosed herein. Certain elements of the exemplary system 700 may be similar to those illustrated in and described in reference to FIG. 1, and, accordingly, similar elements may be denoted with like numerals. In certain embodiments, a selected requester may be provided, separately or as a component of access/authentication credentials, the capability to provide third parties with secondary access to the camera systems 102-108. For example, as illustrated, the users of user devices 118-120 may wish to access a remotely accessible resource of “Camera 1” 102 and the ability to provide secondary access to third parties. Accordingly, user device 118 and user device 120 may generate and transmit to the request management system 126 requests for access to “Camera 1” 102 that includes the ability to grand secondary access (i.e., “Request 1” and “Request 2” respectively).

The request management unit 132 of the request management system 126 may determine that “Request 2” is a selected request and was received from user device 120. The access control unit 134 of the request management system 126 may then generate and transmit access/authentication credentials to the selected user device that may be used by the user device 120 to access “Camera 1” 102. A license allowing the user of user device 120 to provide secondary access to “Camera 1” 102 may also be generated by the request management system 126 and transmitted to user device 120 as a part of or separately from the access/authentication credentials.

The user of user device 124, while not submitting a request to the request management system 126, may wish to secure access to “Camera 1” 102. User device 124 may communicate with user device 120 via a suitable communication medium (e.g., cellular network, wireless, Ethernet, etc.) and determine that user device 120 has a license to provide secondary access to “Camera 1” 102. User device 124 may transmit an indication of authorization to user device 120. In response to the indication of authorization, user device 120 may then transmit to user device 124 access/authentication credentials that may be used to access “Camera 1” 102, which in certain embodiments may be the same access/authentications credentials issued to user device 120 by the request management system 126. The user of user device 124 may then use the access/authentication credentials transmitted from user device 120 to access “Camera 1” 102.

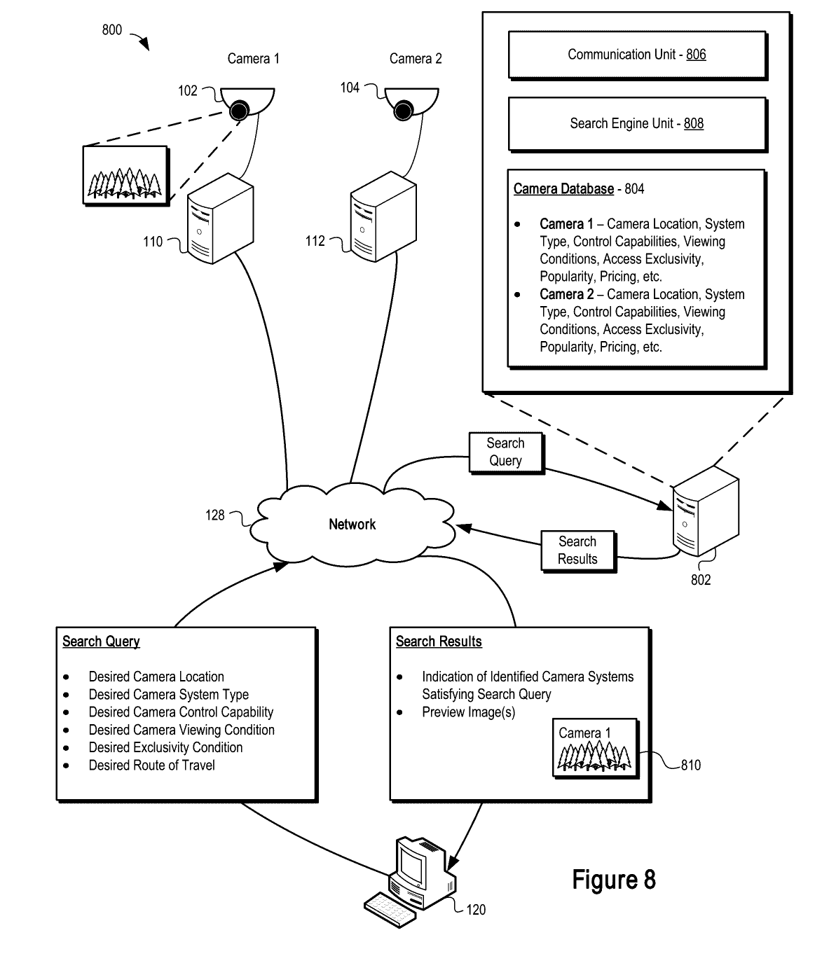

FIG. 8 illustrates an exemplary system 800 for identifying one or more camera systems 102-104 of interest to a user consistent with embodiments disclosed herein. Certain elements of the exemplary system 100 may be similar to those illustrated in and described in reference to FIG. 1, and, accordingly, similar elements may be denoted with like numerals. As discussed above, embodiments disclosed herein provide a system for providing remote access to one or more camera systems 102-104 from a plurality of users (e.g., system 100). In certain circumstances, however, a user may not be aware of available cameras that the user may request for access.

Consistent with further embodiments disclosed herein, the illustrated system 800 may enable a user of a user device 120 to identify one or more camera systems 102-104 of interest to the user. Identification of camera systems (e.g., “Camera 1” 102 and/or “Camera 2” 104) of interest to a user may be facilitated by a search management system 802. The search management system 802 may be communicatively coupled to the one or more user devices 120, the one or more camera systems 102-104, and/or the one or more camera system computers 110-112 via the network 128.

Camera systems 102-104 may register with the search management system 802 so as to be available for further searches. In certain embodiments, registering with the search management system 802 may comprise generating and/or transmitting to the search management system 802 certain identification and/or other system information, collectively described herein as “camera system information,” relating to a camera system 102-104 being registered. For example, a camera system 102-104 and/or an associated camera computer system 110-112 may transmit to the search management system 802 as part of a registration process camera system information comprising unique camera identification information (e.g., “Camera 1” and “Camera 2”), location information describing the location of the camera, a type of camera system (e.g., still image, video image, 3D, etc.), remotely accessible control capabilities or resources, camera viewing conditions (e.g., weather), available types of access exclusivity (e.g., exclusive access, non-exclusive access, etc.), popularity information obtained by monitoring access of the camera system, exchange information (e.g., minimum request amounts and the like), and/or any other type of information or attribute related to a camera system 102-104 that a user may wish to utilize in a search for a camera of interest. In certain embodiments, all or a portion of the camera system information may be generated by the search management system 802 itself through its interactions with the camera systems 102-104, camera computer system 110-112, and/or user devices 120.

The camera system information may be transmitted to the search management system 802 via a communication unit 806 executing thereon that is configured to coordinate communication with other devices (e.g., camera systems 102-104, camera computer systems 110-112, user device 120) communicatively coupled to the search management system 802 via the network 128. The search management system 802 may store the camera system information in a searchable camera database 804.

Users may utilize user devices 120 to transmit to the search management system 802 a search query. The search query may comprise one or more search parameters including, for example, one or more desired camera locations (e.g., physical location or location relative to another location, person, or object, etc.), camera system types (e.g., still image, video image, 3D, etc.), remotely accessible control capabilities or resources (e.g., orientation, exposure control, lighting control, etc.), camera viewing conditions (e.g., weather), camera exclusivity conditions (e.g., available exclusive access, non-exclusive access, etc.), camera locations along a specified route of travel, and/or any other information a user may wish to utilize to identify a potential camera system of interest.

The search query may be received by the search management system 802 via the communication unit 806. A search engine unit 808 executing on the search management system 802 may search the camera system information stored in the camera database 804 and generate search results identifying one or more camera systems 102-104 of potential interest to the user based on the search query. In certain embodiments, the search of the camera database 804 and/or the generation of search results may be performed by the search engine unit 808 utilizing any suitable searching, indexing, and/or information retrieval rules and/or methods.

The search results generated by the search engine unit 808 may be transmitted from the search management system 802 to the user device 102 that originated the search query. As discussed above, the search results may identify one or more camera systems 102-104 of potential interest to the user based on the search query. In certain embodiments, in identifying the one or more camera systems 102-104, the search results may also identify one or more of the search query parameters satisfied by the identified camera systems 102-104 of potential interest. For example, if a camera system 102-104 identified in the search results satisfies a first parameter of the search query (e.g., 3D image capture capability), the search results may indicate in relation to the identified camera system 102-104 that the camera system 102-104 satisfies the first parameter (e.g., “Camera 1—3D image capture capable” or the like). In certain embodiments, a preview image 810 may also be provided in relation to camera systems 102-104 identified in the search results. Utilizing the search results, a user may determine if any of the identified cameras systems 102-104 are of actual interest and, utilizing systems and methods describe above, engage in a process of selectively providing remote access for access to the camera systems 102-104.

It will be appreciated that a number of variations can be made to the architecture and relationships presented in connection with FIG. 8 within the scope of the inventive body of work. For example, certain functionalities of the search management system 802 may be included in the one or more camera systems 102-104, one or more camera computer systems 110-112, one or more user devices 120, and or request management system 126 described above. In some embodiments, other described system functionalities may be similarly distributed between the illustrated systems and/or devices 102-104, 110-112, 120, 126, 802. Thus, it will be appreciated that the system 800 of FIG. 8 is provided for purposes of illustration and explanation, and not limitation.

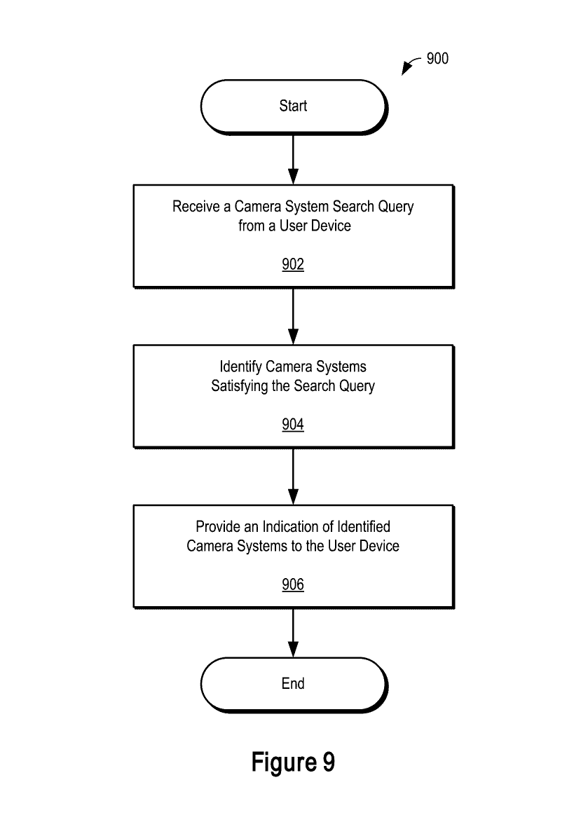

FIG. 9 illustrates a flow chart of an exemplary method 900 for managing a camera search query from a user consistent with embodiments disclosed herein. At 902, a search management system (e.g., search management system 802) may receive a search query from an out-of-network user device (e.g., user device 120). In certain embodiments, the search query may comprise one or more search parameters that may include a remotely accessible camera control capability or resource. In further embodiments, the one or more search parameters may include a desired camera location and a viewing condition. The one or more search parameters may further include any other information a user may wish to utilize to identify a potential camera system of interest (e.g., camera system types, camera exclusivity conditions, camera locations along a specified route of travel, etc.).

The search management system may identify one or more camera systems satisfying the search query, at 904. In certain embodiments, identifying one or more camera systems satisfying the search query may comprise searching a camera database (e.g., camera database 804) storing camera system information of one or more camera systems, and identifying one or more camera systems in the camera database relating and/or relevant to search parameters of the search query. After identifying one or more camera systems satisfying the search query, at 906, the search management system may provide, to the user device that sent the search query, search results comprising an indication of the one or more of the identified camera systems. In certain embodiments, the search results may further comprise an indication of what search parameters of the search query are satisfied by the one or more identified camera systems. The search results may be provided to the user device by sending the results to the user device electronically (e.g., via e-mail, via wireless transmission, etc.). Alternatively or in addition to, the search results may be provided to the user device by posting them to a website, by providing an access code, and/or by any other suitable method.

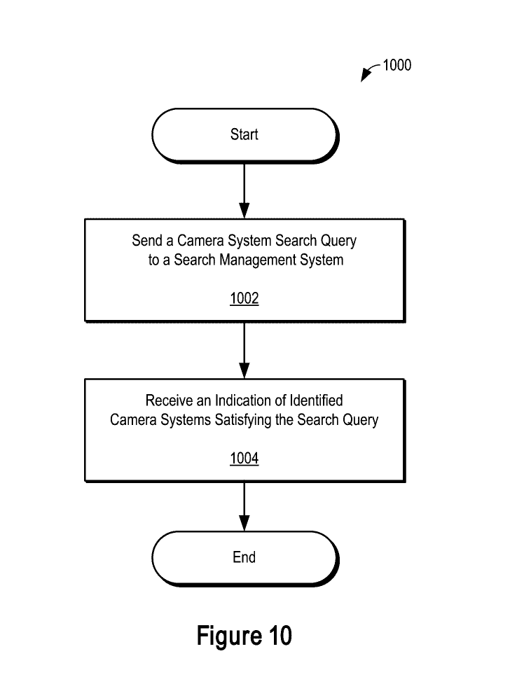

FIG. 10 illustrates a flow chart of an exemplary method 1000 for searching for one or more cameras of interest (e.g., cameras systems 102-108) consistent with embodiments disclosed herein. At 1002, a user device (e.g., user device 120) may send to an out-of-network search management system (e.g., search management system 802) a search query. In certain embodiments, the search query may comprise one or more search parameters related to a potential camera system of interest including, for example, a desired location and viewing condition and/or a remotely accessible camera control capability or resource. The one or more search parameters may further include any other information a user may wish to utilize to identify a potential camera system of interest.

The search query may be received by the search management system that may identify one or more camera systems satisfying the search query by searching a camera database (e.g., camera database 804) storing camera system information of one or more camera systems. After identifying one or more camera systems satisfying the search query, the search management system may generate and transmit an indication that may be received by the user device.

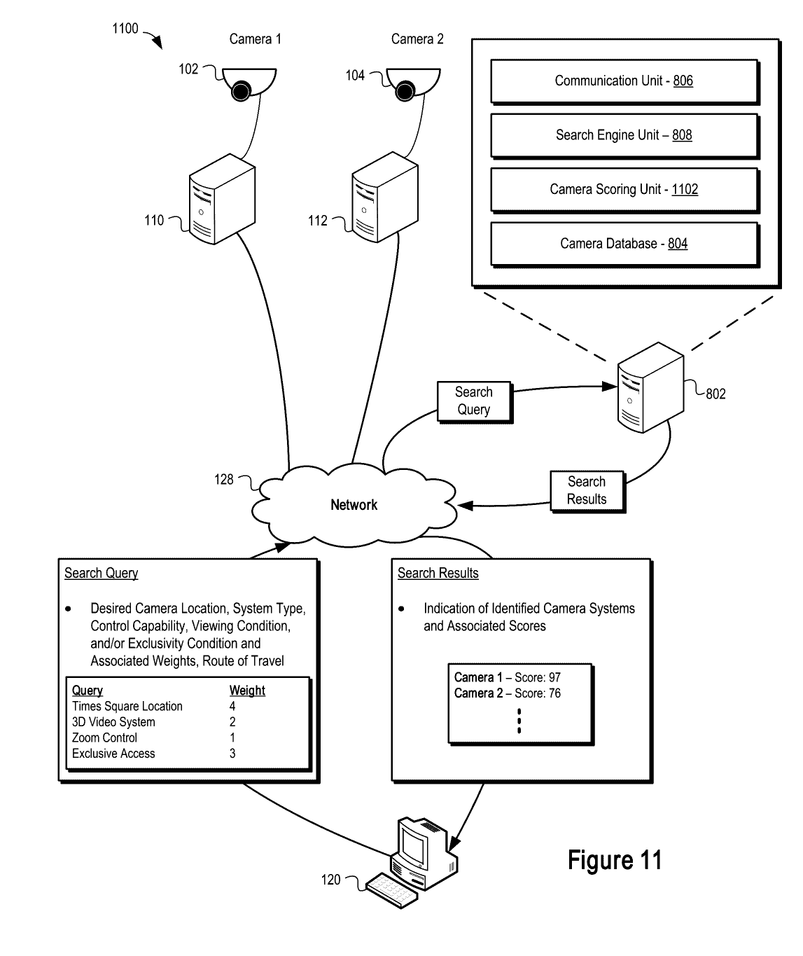

FIG. 11 illustrates an exemplary system 1100 for identifying one or more camera systems 102-104 of interest to a user utilizing a search query weighting process consistent with embodiments disclosed herein. Certain elements of the exemplary system 1100 may be similar to those illustrated in and described in reference to FIG. 1 and FIG. 8, and, accordingly, similar elements may be denoted with like numerals. In certain embodiments, a user may, as part of a search query sent to a search management system 802, provide information relating to a relative degree of importance (e.g., an associated weight) of one or more search parameters included in the search query in identifying a potential camera of interest 102-104. For example, as illustrated, the user of user device 120 may generate a search query that comprises a desired camera location and associated weight (e.g., “Time Square Location—Weight 4”), a camera system type and associated weight (e.g., “3D Video System—Weight 2”), a camera control capability or resource and associated weight (e.g., “Zoom Control—Weight 1”), and a camera exclusivity condition and associated weight (e.g., “Exclusive Access—Weight 3”). Any other information relating to a relative degree of importance of one or more of the search parameters may also be included in the search query.

The search management system 802 may receive the search query and, using a search engine unit 808 executing thereon, perform a search of the camera system information stored in the camera database 804 to identify one or more camera systems 102-104 of potential interest to a user relating and/or relevant to the search parameters of the search query. A camera scoring unit 1102 executing on the search management system 802 may receive an indication of the one or more camera systems 102-104 identified by the search engine unit 808 and the information relating to a relative degree of importance of the search parameters included in the search query. Based on this received information and certain camera scoring or scoring metrics and/or rules, the camera scoring unit 1102 may determine a relative score and/or rank of each identified camera system 102-104 of potential interest. In certain embodiments, the relative score and/or rank may reflect how well the identified camera systems satisfy one or more of the search parameters included in the search query. For example, a camera system 102-104 that satisfies all search parameters included in a search query designated as highly important may receive a higher score and/or rank than a camera system 102 that satisfies fewer search parameters included in a search query designated as highly important. Search results including an indication of the one or more identified camera systems 102-104 and their associated scores and/or ranks may be sent to a requesting user device 120 from the search management system 802.

Some of the infrastructure that can be used with embodiments disclosed herein is already available, such as general-purpose computers, user devices, cameras and associated image processing components, microphones and associated audio processing components, computer programming tools and techniques, digital storage media, and communications networks. A computing device may include a processor such as a microprocessor, microcontroller, logic circuitry, or the like. The processor may include a special purpose processing device such as an ASIC, PAL, PLA, PLD, FPGA, or other customized or programmable device. The computing device may also include a computer-readable storage device such as non-volatile memory, static RAM, dynamic RAM, ROM, CD-ROM, disk, tape, magnetic, optical, flash memory, or other computer-readable storage medium.

Various aspects of certain embodiments may be implemented using hardware, software, firmware, or a combination thereof. As used herein, a software unit or component may include any type of computer instruction or computer executable code located within or on a non-transitory computer-readable storage medium. A software unit may, for instance, comprise one or more physical or logical blocks of computer instructions, which may be organized as a routine, program, object, component, data structure, etc., that performs one or more tasks or implements particular abstract data types. Units may also be implemented using hardware, firmware, or any combination thereof.

In certain embodiments, a particular software unit may comprise disparate instructions stored in different locations of a computer-readable storage medium, which together implement the described functionality of the unit. Indeed, a unit may comprise a single instruction or many instructions, and may be distributed over several different code segments, among different programs, and across several computer-readable storage media. Some embodiments may be practiced in a distributed computing environment where tasks are performed by a remote processing device linked through a communications network.

The systems and methods disclosed herein are not inherently related to any particular computer or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a unit, component, subroutine, or other unit suitable for use in a computing environment. Further, a computer program can be deployed to be executed on one computer or on multiple computers at one site or distributed across multiple sites and interconnected by a communication network. Software embodiments may be implemented as a computer program product that comprises a non-transitory storage medium configured to store computer programs and instructions that, when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic tape, a Bernoulli drive, a magnetic disk, a punch card, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the invention is not to be limited to the details given herein, but may be modified within the scope and equivalents of the appended claims.

The foregoing specification has been described with reference to various embodiments. However, one of ordinary skill in the art will appreciate that various modifications and changes can be made without departing from the scope of the present disclosure. For example, various operational steps, as well as components for carrying out operational steps, may be implemented in alternate ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element. As used herein, the terms “comprises,” “comprising,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

Those having skill in the art will appreciate that many changes may be made to the details of the above-described embodiments without departing from the underlying principles of the invention. The scope of the present invention should, therefore, be determined only by the following claims.

What is claimed is:

1. A method performed by at least one processor and at least one non-transitory computer-readable medium, each computer-readable medium storing instructions that, when executed by a respective processor, cause the processor to perform the method, the method comprising:
receiving a plurality of requests for remotely accessing a camera system from a plurality of requesters;
determining at least one selected request and corresponding selected requester from the plurality of requests; and
providing access to the camera system to each selected requester.

2. The method of claim 1, wherein providing access comprises providing exclusive access to the camera system to each selected requester during a respective time interval.

3. The method of claim 1, wherein providing access comprises providing exclusive access to a resource of the camera system to each selected requester.

4-5. (canceled)

6. The method of claim 1, wherein providing access comprises providing access to the camera system at a particular point in time.

7. (canceled)

8. The method of claim 6, wherein the point in time begins when the at least one selected request is determined.

9. The method of claim 6, wherein at least one request includes an indication of a preferred time to access the camera system.

10. The method of claim 6, wherein at least one request includes an indication of a preferred time interval in which to access the camera system.

11-12. (canceled)

13. The method of claim 1, wherein providing access to the camera system comprises providing access to one or more resources of the camera system.

14-18. (canceled)

19. The method of claim 13, wherein a resource includes a portion of a field of view of the camera system.

20. (canceled)

21. The method of claim 13, wherein a resource includes orientation control of the camera system.

22. The method of claim 21, wherein the orientation control includes one or more of a tilting, panning, and zooming the camera system.

23. (canceled)

24. The method of claim 13, wherein a resource includes focusing control of the camera system.

25-40. (canceled)

41. The method of claim 1, wherein a selected request includes a highest request amount of the plurality of requests.

42. The method of claim 1, wherein a selected request comprises a request per use.

43. The method of claim 1, wherein a selected request comprises a request per period of access.

44-46. (canceled)

47. A non-transitory computer-readable medium storing instructions that, when executed by one or more processors, cause the respective processors to perform a method comprising:
receiving a plurality of requests for remotely accessing a camera system from a plurality of requesters;
determining at least one selected request and corresponding selected requester from the plurality of requests; and
providing access to the camera system to each selected requester.

48. The non-transitory computer-readable medium of claim 47, wherein providing access comprises providing exclusive access to a resource of the camera system to each selected requester.

49-50. (canceled)

51. The non-transitory computer-readable medium of claim 47, wherein a selected request is a highest request of the plurality of requests.

52. The non-transitory computer-readable medium of claim 47, wherein a selected request comprises a request range.

53. The non-transitory computer-readable medium of claim 47, wherein a selected request is determined according to one or more rules.

54. A system comprising:
one or more processors; and
one or more non-transitory computer-readable mediums, each non-transitory computer-readable medium storing instructions that, when executed by the respective processors, cause the processors to perform a method comprising:
receiving a plurality of requests for remotely accessing a camera system from a plurality of requesters;
determining at least one selected request and corresponding selected requester from the plurality of requests; and
providing access to the camera system to each selected requester.

55. The system of claim 54, wherein providing access comprises providing exclusive access to a resource of the camera system to each selected requester.

56. The system of claim 54, wherein providing access comprises providing non-exclusive access to a resource of the camera system to each selected requester.

57. The system of claim 54, wherein providing access comprises providing access to one or more resources of the camera system.

58. The system of claim 54, wherein a selected request is a highest request of the plurality of requests.

59. The system of claim 54, wherein a selected request comprises a request range.

60. The system of claim 54, wherein a selected request is determined according to one or more rules.

61. A system comprising:
a processor;
a computer-readable medium coupled to the processor and including a plurality of units executable by the processor, the units comprising:
a communication unit configured to receive a plurality of requests for remotely accessing a camera system from a plurality of requesters;
a request determination unit configured to determine at least one selected request and corresponding selected requester from the plurality of requests; and
an access control unit configured to provide access to the camera system to each selected requester.

62. The system of claim 61, wherein the access control unit is further configured to provide exclusive access to a resource of the camera system to each selected requester.

63. (canceled)

64. The system of claim 61, wherein providing access comprises providing access to one or more resources of the camera system.

65. The system of claim 61, wherein a selected request is a highest request of the plurality of requests.

66. The system of claim 61, wherein a selected request comprises a request range.

67. The system of claim 54, wherein the request determination unit is further configured to determine a selected request according to one or more rules.
